(19) United States
(12) Patent Application Publication
(10) Pub. No.: US 2021/0319618 A1
(43) Pub. Date: Oct. 14, 2021

(54) METHOD AND APPARATUS FOR DISPLAYING STEREOSCOPIC STRIKE ZONE

(71) Applicant: 4DREPLAY KOREA, INC., Seoul (KR)

(72) Inventors: Sang Yun LEE, Seoul (KR); Woong Ki KIM, Gyeonggi-do (KR)

(21) Appl. No.: 17/292,367

(22) PCT Filed: Nov. 22, 2018
(86) PCT No.: PCT/KR2018/014434

§ 371 Date: May 7, 2021

(30) Foreign Application Priority Data
Nov. 16, 2018 (KR) 10-2018-0141963

(51) Int. Cl. G06T 15/20; G06T 7/292

(52) U.S. Cl. CPC G06T 15/205; G06T 7/292; G06T 2207/30241; G06T 2207/30224; G06T 2215/16

(57) ABSTRACT

In a method and an apparatus for displaying a 3D strike zone according to an embodiment, rotation information and translation information of a ball are estimated on the basis of corresponding coordinates between a 3D coordinate system and 2D coordinates value, and the strike zone is displayed in a multichannel image or is expressed to be three-dimensional on the basis of the rotation information and the translation information, such that whether a ball thrown by a pitcher has passed through the strike zone may be determined at various angles.

### TECHNICAL FIELD

Embodiments relate to a method and apparatus for displaying a 3D strike zone.

### BACKGROUND ART

Recently, the public prefer to replay videos using mobile devices. Along with this preference, companies provide broadcast platform services such as V-app, AfreecaTV, and Youtube Live services. Images that people watch through these platforms are captured at one viewpoint, that is, captured by one camera. However, recently, viewers want to watch images captured in a desired space.

At present, imaging services are open to the public, which provides multichannel images to users by geometrically correcting and multiplexing a plurality of images acquired by photographing one subject in various channels with a plurality of cameras. Such multichannel images are realistic, surpassing the concept of high definition, making users more immersed in media, and significantly enhancing the effect of delivering image information in the fields of advertisement, education, medical service, national defense, entertainment, and the like.

A multichannel image of the related art is simply played back in a merge mode in which channel/time switching occurs by a method previously set when producing the multichannel image. That is, according to the related art, one channel-switching image is produced by acquiring a plurality of frames using a plurality of cameras, selecting some of the acquired frames, and merging the selected frames. Such a channel-switching image is produced by simply merging frames of channels which are previously determined by a producer, and thus, when such an image file is played back, a channel-switching effect occurs in which merged frames exhibit a single channel shift effect. With such multichannel images of the related art, users or views merely enjoy a pre-produced simple channel switching effect and are not allowed to manually manipulate time switching or channel switching to watch images while turning channels to desired viewpoints.

Furthermore, in baseball broadcasting, it is a common technique to show, on a 2D baseball broadcast screen, whether a pitch thrown by a pitcher is a strike or ball, or whether the pitch passes through a strike zone. However, there are many technical difficulties in displaying or three-dimensionally displaying the strike zone in such a multichannel image as described above.

### DESCRIPTION OF EMBODIMENTS

### Technical Problem

An objective of embodiments is to provide a method and apparatus for displaying a 3D strike zone.

### Solution to Problem

According to an embodiment, a method of displaying a 3D strike zone includes: setting a 3D coordinate system based on coordinates of at least four reference points of batter's boxes including a home plate; setting coordinates of the 3D strike zone which correspond to the 3D coordinate system; acquiring 2D coordinates of the batter's boxes on a 2D image plane projected onto each of a plurality of cameras for generating a multichannel image; estimating rotation information and translation information based on corresponding coordinates between the 3D coordinate system and the 2D coordinates; and displaying the 3D strike zone on the 2D image plane projected onto each of the plurality of cameras based on the rotation information and translation information.

The rotation information and translation information are estimated based on the corresponding coordinates between the 3D coordinate system and the 2D coordinates by Levenberg-Marquardt optimization, Perspective-Three-Point, or a least-squares method.

The coordinates of the 3D strike zone are ten, and two values (h1 and h2) of the ten coordinates are variable depending on a height of a batter who is at bat.

The height of the batter is extracted from an arbitrary database or by detection from an image of the batter.

The method further includes detecting and tracking a trajectory of a pitch thrown by a pitcher, wherein whether the pitch is a strike is determined by detecting whether the pitch passes through the displayed 3D strike zone.

According to another embodiment, an apparatus for displaying a 3D strike zone includes: a 3D coordinate setting unit that sets a 3D coordinate system based on coordinates of at least four reference points of batter's boxes including a home plate, and sets coordinates of the 3D strike zone which correspond to the set 3D coordinate system; a 3D strike zone generation unit that acquires 2D coordinates of the batter's boxes on a 2D image plane projected onto each of a plurality of cameras for generating a multichannel image, and estimates rotation information and translation information based on corresponding coordinates between the 3D coordinate system and the 2D coordinates; and an image processing unit that displays the 3D strike zone on the 2D image plane projected onto each of the plurality of cameras based on the rotation information and translation information.

The rotation information and translation information are estimated based on the corresponding coordinates between the 3D coordinate system and the 2D coordinates by Levenberg-Marquardt optimization, Perspective-Three-Point, or a least-squares method.

The coordinates of the 3D strike zone are ten, and two values (h1 and h2) of the ten coordinates are variable depending on a height of a batter who is at bat.

The height of the batter is extracted from an arbitrary database or by detection from an image of the batter.

The apparatus further includes a trajectory tracking unit that detects and tracks a trajectory of a pitch thrown by a pitcher, wherein whether the pitch is a strike is determined by detecting whether the pitch passes through the displayed 3D strike zone.

According to another embodiment, a recording medium has recorded thereon a program for executing the method.

### Advantageous Effects of Disclosure

According to the method and apparatus for displaying a 3D strike zone, a strike zone is displayed in a multichannel image or is three-dimensionally displayed in a multichannel image, making it possible to determine, at various angles, whether a pitch thrown by a pitcher has passed through the strike zone.

### BRIEF DESCRIPTION OF DRAWINGS

FIG. 1 is a view schematically illustrating a transmission system 100 for multichannel images, according to an embodiment.

FIG. 2 is a view illustrating an example of generating a multichannel image.

FIG. 3 is a view schematically illustrating how a 3D strike zone 300 is displayed according to an embodiment.

FIG. 4 is a schematic view illustrating an image processing device 130 shown in FIG. 1.

FIGS. 5 to 9 are views illustrating how a 3D strike zone is generated and displayed according to another embodiment.

### MODE OF DISCLOSURE

The terms used in embodiments are general terms currently widely used in the art in consideration of functions regarding the embodiments, but the terms may vary according to the intention of those of ordinary skill in the art, precedents, or new technology in the art. Also, some terms may be arbitrarily selected, and in this case, the meaning of the selected terms will be described in detail in embodiments. Thus, the terms used herein should not be construed based on only the names of the terms but should be construed based on the meaning of the terms together with the description throughout the embodiments.

In the following descriptions of embodiments, when a portion is referred to as being connected to another portion, the portion may be directly connected to the other portion, or may be electrically connected to the other portion with intervening portions being therebetween. In addition, the expression that a certain part includes an element means, unless otherwise specified, that the part may further include other elements, rather than precluding the presence or addition of other elements. In the descriptions of the embodiments, terms such as “ . . . unit” are used to denote a unit having at least one function or operation and implemented with hardware, software, or a combination of hardware and software.

In the following descriptions of the embodiments, expressions or terms such as “constituted by,” “formed by,” “include,” “comprise,” “including,” and “comprising” should not be construed as always including all specified elements, processes, or operations, but may be construed as not including some of the specified elements, processes, or operations, or further including other elements, processes, or operations.

The following descriptions of the embodiments should not be construed as limiting the scope of the present disclosure, and modifications or changes that could be easily made from the embodiments by those of ordinary skill in the art should be construed as being included in the scope of the present disclosure. Hereinafter, example embodiments will be described with reference to the accompanying drawings.

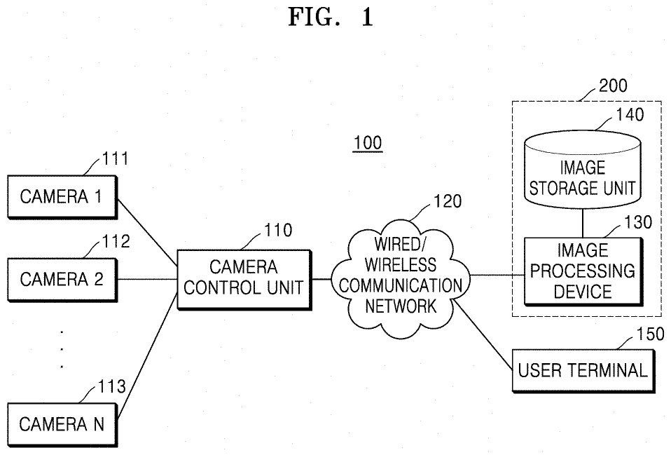

FIG. 1 is a view schematically illustrating a transmission system 100 for multichannel images, according to an embodiment.

Referring to FIG. 1, the transmission system 100 includes a plurality of cameras 111 to 113, a camera control unit 110 configured to control the plurality of cameras 111 to 113 and process and transmit multichannel images captured by the plurality of cameras 111 to 113, and an image server 200 configured to process and store the multichannel images transmitted from the camera control unit 110. The image server 200 receives a request for a multichannel image, a request for a switching image, and a request for a specific event from a user terminal 150, and transmits a stored multichannel image to the user terminal 150. The image server 200 may include an image processing device 130 and an image storage unit 140.

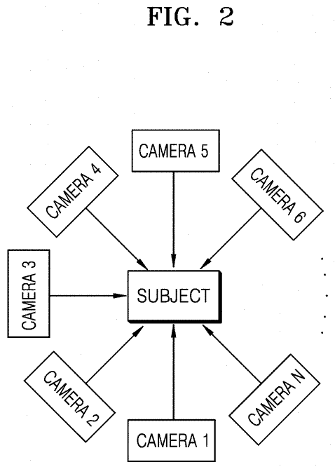

As shown in FIG. 2, a plurality of cameras 1 to N may be arranged to photograph a specific subject. A plurality of images obtained by photographing the subject at multiple angles are received from the plurality of cameras which are arranged in an array around the subject. A method of arranging the plurality of cameras may include, for example, arranging N cameras in a line substantially on the same plane with respect to an arbitrary camera. In this case, the N cameras may be sequentially arranged along a circumference separated from the subject by a predetermined distance, or may be arranged such that two cameras arranged at both sides of a center camera may be separated from the subject by the same distance and the other cameras may be separated from the subject by different distances. In addition, the subject may be a stationary subject or a moving subject.

The plurality of cameras 1 to N may communicate with the camera control unit 110 in a wired or wireless manner, and a plurality of camera control units may be provided for controlling the plurality of cameras 1 to N.

The camera control unit 110 may control the plurality of cameras 1 to N using a synchronization signal for synchronizing the plurality of cameras 1 to N. The camera control unit 110 temporarily stores images captured using the plurality of cameras 1 to N and reduces the sizes of the captured images by changing a codec to enable quick transmission of the captured images.

The image server 200 generates and displays a 3D strike zone for at least one image among multichannel images transmitted from the camera control unit 110.

The image server 200 transmits multichannel images through a communication network 120 according to a request from the user terminal 150. In addition, the image server 200 groups and stores multichannel images including a 3D strike zone on the basis of at least one of time, channel, or a combination of time and channel, and transmits the grouped multichannel images to the user terminal 150 through the communication network 120 according to a request from the user terminal 150.

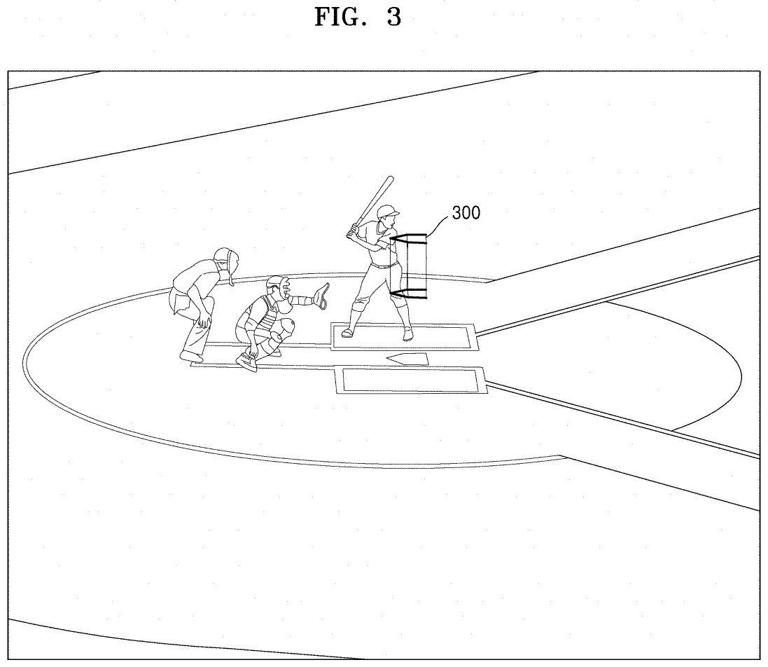

FIG. 3 is a view schematically illustrating a 3D strike zone 300 according to an embodiment.

Referring to FIG. 3, according to an embodiment, a multichannel image transmission system displays a baseball broadcast image captured by a specific camera, for example, the camera 1 shown in FIG. 2, together with a 3D strike zone 300. Here, the same 3D strike zone may also be displayed on the baseball broadcast images captured by the other cameras 2 to N. In this case, a pitch thrown by a pitcher may be determined as a ball or strike depending on whether the pitch has passed through the 3D strike zone 300, and while detecting and tracking the trajectory of the pitch thrown by the pitcher, whether the pitch has passed through the 3D strike zone 300 may be displayed. Therefore, when a user views a baseball broadcast screen while switching to an image captured at a desired angle (or by a desired camera), a virtual 3D strike zone 300 may be generated and displayed together with the image.

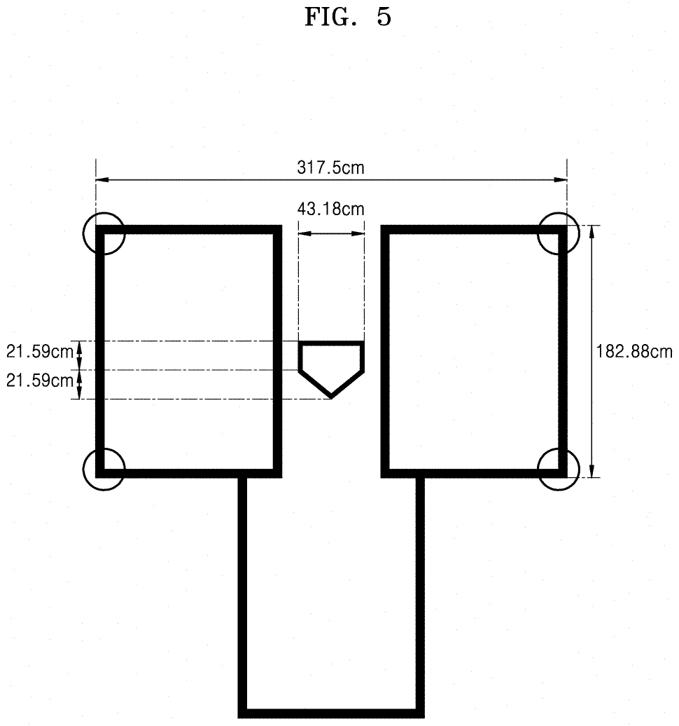

The multichannel image transmission system estimates information on the coordinates of a strike zone from an image captured by each camera, acquires rotation information and translation information in the plane of the image captured by each camera by using the standard of actual batter's boxes and information on the coordinates of the batter's boxes in the image, estimates ten coordinates constituting the strike zone using these pieces of information, and projects the ten coordinates onto the image. Here, ten coordinates are estimated according to the pentagonal shape of the strike zone, but the number of coordinates is not limited thereto. A detailed method of generating and displaying a 3D strike zone will be described with reference to FIGS. 5 to 9.

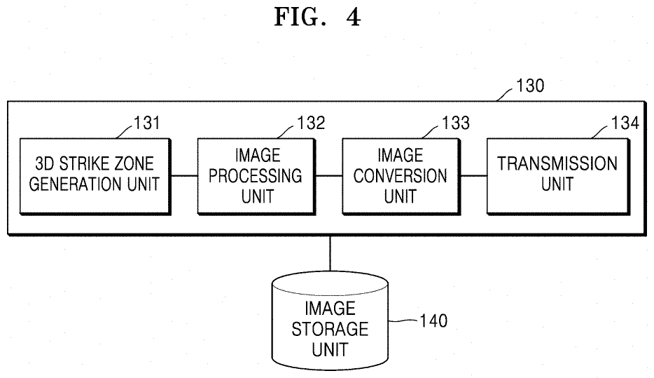

FIG. 4 is a view schematically illustrating the image processing device 130 shown in FIG. 1.

Referring to FIG. 4, the image processing device 130 includes a 3D strike zone generation unit 131, an image processing unit 132, an image conversion unit 133, and a transmission unit 134. According to an embodiment, the image processing device 130 is for processing images for a baseball broadcast streaming service, and has a function of generating and displaying a 3D strike zone.

The 3D strike zone generation unit 131 sets a 3D coordinate system based on four reference coordinates of batter's boxes including a home plate, and sets coordinates of a 3D strike zone which correspond to the set 3D coordinate system. In addition, 2D coordinates of the batter's boxes are acquired from the plane of a 2D image projected onto each of a plurality of cameras for generating a multichannel image, and rotation information and translation information are estimated based on corresponding coordinates between the 3D coordinate system and the 2D coordinates.

FIGS. 5 to 9 are examples views illustrating how a 3D strike zone is generated and displayed according to another embodiment.

Referring to FIG. 5, dimensions of batter's boxes in an actual baseball field are shown. The home plate between the batter's boxes has a pentagonal shape measuring 43.18 cm in width and length and is divided into 21.59-cm parts forming pentagonal vertexes. The left-handed and right-handed batter's boxes are 317.5 cm in total width and 182.88 cm in length.

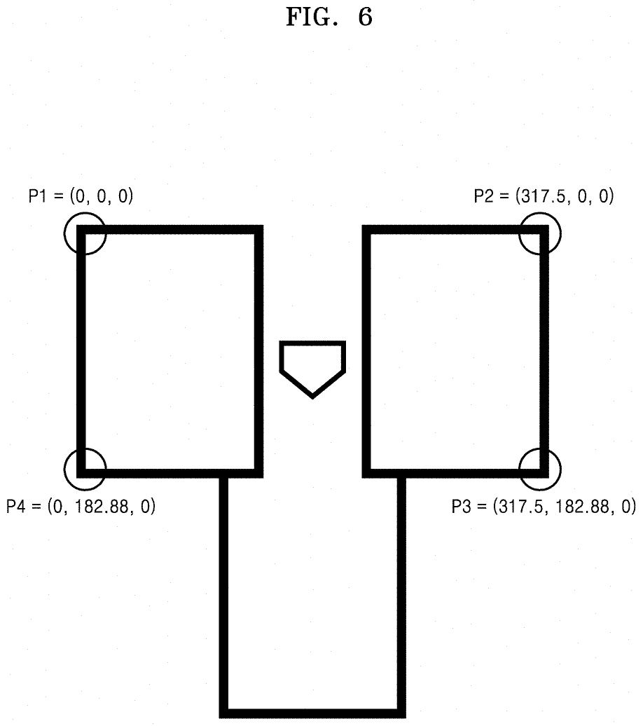

Referring to FIG. 6, coordinates of four corners may be set as 3D coordinates based on the actual dimensions of the batter's boxes shown in FIG. 5. As shown in FIG. 6, P1 (0, 0, 0), P2 (317.5, 0, 0), P3 (0, 182.88, 0), and P4 (317.5, 182.88, 0) are set. Here, although the four coordinates P1 to P4, or four corners of the batter's boxes are set as reference coordinates, reference coordinates are not limited thereto, and various coordinates may be set as reference coordinates.

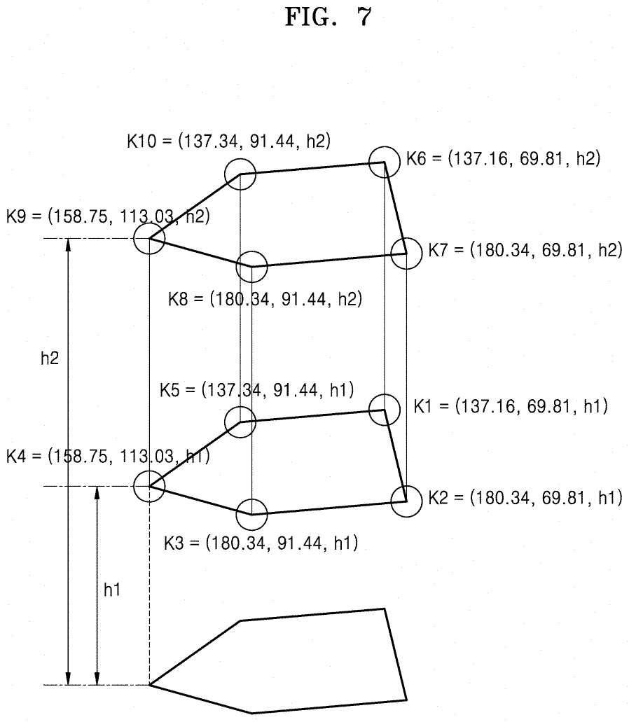

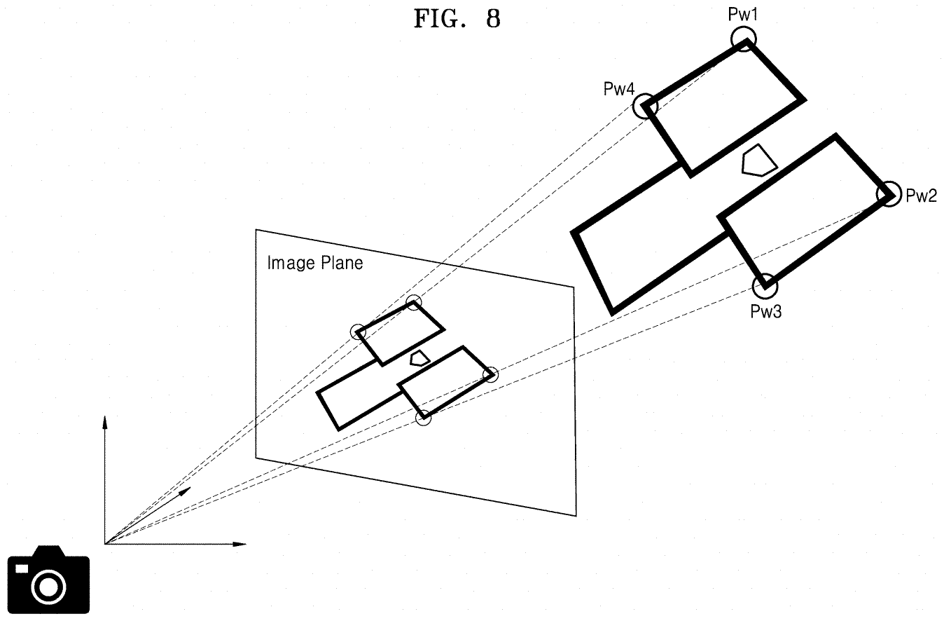

Referring to FIG. 7, coordinates K1 to K10 of the 3D strike zone are set based on the size of the home plate such that the coordinates K1 to K10 may correspond to the 3D coordinates shown in FIG. 6. Here, h1 and h2 are parameters that are variable according to the characteristics of the strike zone of which the height varies with the body type or height of a batter. For example, h1 and h2 have large values for a tall batter and small values for a short batter. The height of a batter may be read from a separate database, for example a database containing detailed information on baseball players, or may be measured by detecting an image of the batter from a baseball broadcast image to determine the values of h1 and h2 by reflecting results of the measurement.

As shown in FIG. 7, the five coordinates K1 to K5 on a lower surface of the 3D strike zone and the five coordinates K6 to K10 of an upper surface of the 3D strike zone, which are based on the home plate on a bottom surface, are as follows.

The ten coordinates constituting the 3D strike zone are K1 (137.16, 69.81, h1), K2 (180.34, 69.81, h1), K3 (180.34, 91.44, h1), K4 (158.75, 113.03). h1), K5 (137.34, 91.44, h1), K6 (137.16, 69.81, h2), K7 (180.34, 69.81, h2), K8 (180.34, 91.44, h2), K9 (158.75, 113.03, h2), and K10 (137.34, 91.44, h2). The coordinates of the batter's boxes or the 3D strike zone in the embodiment are examples and do not need to have exact numerical values, and even when only the ratios of the coordinates correspond to the ratios of exact values, the batter's boxes or the 3D strike zone may be implemented. Here, as described above, h1 and h2 may be values varying depending on the height of a batter.

Referring to FIG. 8, 3D coordinates of batter's boxes and a home plate are used which correspond to 2D coordinates formed on the plane of an image captured by a specific camera, for example, one of the plurality of cameras shown in FIG. 2. Here, a method such as Levenberg-Marquardt optimization, Perspective-Three-Point, or a least-squares method be used for calculating corresponding coordinates. Rotation information and translation information are estimated by such a method to combine a 3D strike zone with an image captured by a specific camera. That is, when at least three coordinates projected from a 3D coordinate system to each 2D coordinate system are known, rotation information and translation information on each 2D coordinate system may be estimated. Here, although the use of a method such as Levenberg-Marquardt optimization, Perspective-Three-Point, or a least-squares method has been mentioned, such a method is a non-limiting example, and other methods may be used.

With reference to Perspective-n-Point, 3D-2D image projection using rotation information and translation information will now be described in detail. When four or more points on the plane of an image which correspond to coordinates in a particular 3D space are known, rotation information and translation information on the particular 3D space may be acquired. Depending on an algorithm, a pose may be estimated using only three points. That is, when rotation information and translation information are acquired using Perspective-n-Point, specific coordinates in a 3D space may be associated with the plane of an image.

Rotation information R and translation information T may be defined as in Equations 1 and 2 below.

$$\begin{matrix}R = [ \begin{matrix}{R}_{11} & {R}_{12} & {R}_{13} \\ {R}_{21} & {R}_{22} & {R}_{23} \\ {R}_{31} & {R}_{32} & {R}_{33}\end{matrix} ] , & [ Equation 1 ] \\ T = [ \begin{matrix}{t}_{x} \\ {t}_{y} \\ {t}_{z}\end{matrix} ] & [ Equation 2 ]\end{matrix}$$

In addition, assuming that a 3D coordinate is Pw=(Xw, Yw, Zw) and 2D, a 2D projection coordinate is Pc=(Xc, Yc, Zc), the coordinates may be defined as in Equation 3 below.

$$[ \begin{matrix}{X}_{c} \\ {Y}_{c} \\ {Z}_{c} \\ 1\end{matrix} ] = [ \begin{matrix}{R}_{11} & {R}_{12} & {R}_{13} & {t}_{x} \\ {R}_{21} & {R}_{22} & {R}_{23} & {t}_{y} \\ {R}_{31} & {R}_{32} & {R}_{33} & {t}_{z} \\ 0 & 0 & 0 & 1\end{matrix} ] [ \begin{matrix}{X}_{w} \\ {Y}_{w} \\ {Z}_{w} \\ 1\end{matrix} ] \qquad [ Equation 3 ]$$

Here, when Pc is multiplied by internal camera model information M for projection according to an image plane size, Equation 4 below is obtained.

$$M = [ \begin{matrix}{f}_{x} & 0 & {c}_{x} \\ 0 & {f}_{y} & {c}_{y} \\ 0 & 0 & 1\end{matrix} ] , ∴ [ \begin{matrix}x \\ y \\ 1\end{matrix} ] = M * {p}_{c} \qquad [ Equation 4 ]$$

Here, x and y refer to x and y on an actual image plane, and Equation 5 below is obtained from Equation 4.

$$[ \begin{matrix}x \\ y \\ 1\end{matrix} ] = [ \begin{matrix}{f}_{x} & 0 & {c}_{x} \\ 0 & {f}_{y} & {c}_{y} \\ 0 & 0 & 1\end{matrix} ] [ \begin{matrix}{R}_{11} & {R}_{12} & {R}_{13} & {t}_{x} \\ {R}_{21} & {R}_{22} & {R}_{23} & {t}_{y} \\ {R}_{31} & {R}_{32} & {R}_{33} & {t}_{z}\end{matrix} ] [ \begin{matrix}{X}_{w} \\ {Y}_{w} \\ {Z}_{w} \\ 1\end{matrix} ] \qquad [ Equation 5 ]$$

With reference to Equations 1 to 5, Pw1, Pw2, Pw3, and Pw4 are set in the 3D coordinate system as follows. Pw1=(0, 20.183, 0), Pw2=(100, 20.183, 0), Pw3=(100, 79.816, 0), Pw4=(0, 79.815, 0), and rotation information and translation information are as follows.

$$•Rotation information R = [ \begin{matrix}- 0.019 & 0.997 & - 0.064 \\ - 0.401 & 0.051 & 0.915 \\ 0.9 \; 16 & 0.044 & 0.399\end{matrix} ]$$

$$•Translation information T = [ \begin{matrix}- 306.38 \\ - 9 \; 8.25 \\ 1014.44\end{matrix} ]$$

$$• M = [ \begin{matrix}3840 & 0 & 3840 l 2 \\ 0 & 3840 & 2160 / 2 \\ 0 & 0 & 1\end{matrix} ]$$

Then, the coordinates k1 to k10 of the 3D strike zone are as follows.

When k1=(44, 43, −12), k2=(56, 43, −12), k3=(56, 50, −12), k4=(50, 57, −12), k5=(44, 50, −12), k6=(44, 43, −30), k7=(56, 50, −30), k8=(56, 50, −30), k9=(50, 57, −30), and k10=(44, 50, −30), the x and y values of k1 to k10 in the image plane are calculated as shown with Equations 6 to 15 below.

$$\begin{matrix}•When {k}_{1} = ( 44 , 43 , - 12 ) , x and y values in the image plane are : \\ • [ \begin{matrix}x \\ y \\ 1\end{matrix} ] = [ \begin{matrix}3840 & 0 & 3840 l 2 \\ 0 & 3840 & 2160 / 2 \\ 0 & 0 & 1\end{matrix} ] [ \begin{matrix}- 0.019 & 0.997 & - 0.064 \\ - 0.401 & 0.051 & 0.915 \\ 0.9 \; 16 & 0.044 & 0.399\end{matrix} \begin{matrix}- 306.38 \\ - 98.25 \\ 1014.44\end{matrix} ] [ \begin{matrix}44 \\ 43 \\ - 12 \\ 1\end{matrix} ] \\ • ∴ x = 958 , y = 652 & [ Equation 6 ] \\ •When {k}_{2} = ( 56 , 43 , - 12 ) , x and y values in the image plane are : \\ • [ \begin{matrix}x \\ y \\ 1\end{matrix} ] = [ \begin{matrix}3840 & 0 & 3840 l 2 \\ 0 & 3840 & 2160 / 2 \\ 0 & 0 & 1\end{matrix} ] [ \begin{matrix}- 0.019 & 0.997 & - 0.064 \\ - 0.401 & 0.051 & 0.915 \\ 0.9 \; 16 & 0.044 & 0.399\end{matrix} \begin{matrix}- 306.38 \\ - 98.25 \\ 1014.44\end{matrix} ] [ \begin{matrix}56 \\ 43 \\ - 12 \\ 1\end{matrix} ] \\ • ∴ x = 967 , y = 639 & [ Equation 7 ] \\ •When {k}_{3} = ( 56 , 50 , - 12 ) , x and y values in the image plane are : \\ • [ \begin{matrix}x \\ y \\ 1\end{matrix} ] = [ \begin{matrix}3840 & 0 & 3840 l 2 \\ 0 & 3840 & 2160 / 2 \\ 0 & 0 & 1\end{matrix} ] [ \begin{matrix}- 0.019 & 0.997 & - 0.064 \\ - 0.401 & 0.051 & 0.915 \\ 0.9 \; 16 & 0.044 & 0.399\end{matrix} \begin{matrix}- 306.38 \\ - 98.25 \\ 1014.44\end{matrix} ] [ \begin{matrix}56 \\ 50 \\ - 12 \\ 1\end{matrix} ] \\ • ∴ x = 992 , y = 641 & [ Equation 8 ] \\ •When {k}_{4} = ( 50 , 57 , - 12 ) , x and y values in the image plane are : \\ • [ \begin{matrix}x \\ y \\ 1\end{matrix} ] = [ \begin{matrix}3840 & 0 & 3840 l 2 \\ 0 & 3840 & 2160 / 2 \\ 0 & 0 & 1\end{matrix} ] [ \begin{matrix}- 0.019 & 0.997 & - 0.064 \\ - 0.401 & 0.051 & 0.915 \\ 0.9 \; 16 & 0.044 & 0.399\end{matrix} \begin{matrix}- 306.38 \\ - 98.25 \\ 1014.44\end{matrix} ] [ \begin{matrix}50 \\ 57 \\ - 12 \\ 1\end{matrix} ] \\ • ∴ x = 1014 , y = 649 & [ Equation 9 ] \\ •When {k}_{5} = ( 44 , 50 , - 12 ) , x and y values in the image plane are : \\ • [ \begin{matrix}x \\ y \\ 1\end{matrix} ] = [ \begin{matrix}3840 & 0 & 3840 l 2 \\ 0 & 3840 & 2160 / 2 \\ 0 & 0 & 1\end{matrix} ] [ \begin{matrix}- 0.019 & 0.997 & - 0.064 \\ - 0.401 & 0.051 & 0.915 \\ 0.9 \; 16 & 0.044 & 0.399\end{matrix} \begin{matrix}- 306.38 \\ - 98.25 \\ 1014.44\end{matrix} ] [ \begin{matrix}44 \\ 50 \\ - 12 \\ 1\end{matrix} ] \\ • ∴ x = 981 , y = 658 & [ Equation 10 ] \\ •When {k}_{6} = ( 44 , 43 , - 30 ) , x and y values in the image plane are : \\ • [ \begin{matrix}x \\ y \\ 1\end{matrix} ] = [ \begin{matrix}3840 & 0 & 3840 l 2 \\ 0 & 3840 & 2160 / 2 \\ 0 & 0 & 1\end{matrix} ] [ \begin{matrix}- 0.019 & 0.997 & - 0.064 \\ - 0.401 & 0.051 & 0.915 \\ 0.9 \; 16 & 0.044 & 0.399\end{matrix} \begin{matrix}- 306.38 \\ - 98.25 \\ 1014.44\end{matrix} ] [ \begin{matrix}44 \\ 43 \\ - 30 \\ 1\end{matrix} ] \\ • ∴ x = 955 , y = 630 & [ Equation 11 ] \\ •When {k}_{7} = ( 56 , 43 , - 30 ) , x and y values in the image plane are : \\ • [ \begin{matrix}x \\ y \\ 1\end{matrix} ] = [ \begin{matrix}3840 & 0 & 3840 l 2 \\ 0 & 3840 & 2160 / 2 \\ 0 & 0 & 1\end{matrix} ] [ \begin{matrix}- 0.019 & 0.997 & - 0.064 \\ - 0.401 & 0.051 & 0.915 \\ 0.9 \; 16 & 0.044 & 0.399\end{matrix} \begin{matrix}- 306.38 \\ - 98.25 \\ 1014.44\end{matrix} ] [ \begin{matrix}56 \\ 43 \\ - 30 \\ 1\end{matrix} ] \\ • ∴ x = 965 , y = 618 & [ Equation 12 ] \\ •When {k}_{8} = ( 56 , 50 , - 30 ) , x and y values in the image plane are : \\ • [ \begin{matrix}x \\ y \\ 1\end{matrix} ] = [ \begin{matrix}3840 & 0 & 3840 l 2 \\ 0 & 3840 & 2160 / 2 \\ 0 & 0 & 1\end{matrix} ] [ \begin{matrix}- 0.019 & 0.997 & - 0.064 \\ - 0.401 & 0.051 & 0.915 \\ 0.9 \; 16 & 0.044 & 0.399\end{matrix} \begin{matrix}- 306.38 \\ - 98.25 \\ 1014.44\end{matrix} ] [ \begin{matrix}56 \\ 50 \\ - 30 \\ 1\end{matrix} ] \\ • ∴ x = 990 , y = 619 & [ Equation 13 ] \\ •When {k}_{9} = ( 50 , 57 , - 30 ) , x and y values in the image plane are : \\ • [ \begin{matrix}x \\ y \\ 1\end{matrix} ] = [ \begin{matrix}3840 & 0 & 3840 l 2 \\ 0 & 3840 & 2160 / 2 \\ 0 & 0 & 1\end{matrix} ] [ \begin{matrix}- 0.019 & 0.997 & - 0.064 \\ - 0.401 & 0.051 & 0.915 \\ 0.9 \; 16 & 0.044 & 0.399\end{matrix} \begin{matrix}- 306.38 \\ - 98.25 \\ 1014.44\end{matrix} ] [ \begin{matrix}50 \\ 57 \\ - 30 \\ 1\end{matrix} ] \\ • ∴ x = 1016 , y = 621 & [ Equation 14 ] \\ •When {k}_{10} = ( 44 , 50 , - 30 ) , x and y values in the image plane are : \\ • [ \begin{matrix}x \\ y \\ 1\end{matrix} ] = [ \begin{matrix}3840 & 0 & 3840 l 2 \\ 0 & 3840 & 2160 / 2 \\ 0 & 0 & 1\end{matrix} ] [ \begin{matrix}- 0.019 & 0.997 & - 0.064 \\ - 0.401 & 0.051 & 0.915 \\ 0.9 \; 16 & 0.044 & 0.399\end{matrix} \begin{matrix}- 306.38 \\ - 98.25 \\ 1014.44\end{matrix} ] [ \begin{matrix}44 \\ 50 \\ - 30 \\ 1\end{matrix} ] \\ • ∴ x = 981 , y = 632 & [ Equation 15 ]\end{matrix}$$

Through the above-described method, the coordinates of the 3D strike zone in the image plane of each camera may be calculated.

In an embodiment, rotation information R and translation information T are estimated using coordinates in an image plane which match coordinates in a 3D space. Then, a calculation is performed by substituting the values of R and T through a method such as Levenberg-Marquardt optimization, and the calculation may be repeated while correcting and improving the values of R and T until the difference between actual results and calculated results is less than a threshold value. By an approximation through this repetition, R and T may approach actual values, and values closest to the actual values may be selected as R and T. Here, R, T, and M are defined as follows.

$$R = [ \begin{matrix}{R}_{11} & {R}_{12} & {R}_{13} \\ {R}_{21} & {R}_{22} & {R}_{23} \\ {R}_{3 l} & {R}_{32} & {R}_{33}\end{matrix} ] , T = [ \begin{matrix}{t}_{x} \\ {t}_{y} \\ {t}_{z}\end{matrix} ] , M = [ \begin{matrix}{f}_{x} & 0 & {c}_{x} \\ 0 & {f}_{y} & {c}_{y} \\ 0 & 0 & 1\end{matrix} ]$$

Here, when an evaluation function for calculating and evaluating R and T is called F, F may be defined as in Equation 16 below.

$$• F ( k ) = [ \begin{matrix}{f}_{x} & 0 & {c}_{x} \\ 0 & {f}_{y} & {c}_{y} \\ 0 & 0 & l\end{matrix} ] [ \begin{matrix}{R}_{11} & {R}_{12} & {R}_{13} & {t}_{x} \\ {R}_{21} & {R}_{22} & {R}_{23} & {t}_{y} \\ {R}_{31} & {R}_{32} & {R}_{33} & {t}_{z}\end{matrix} ] [ \begin{matrix}{X}_{w} \\ {Y}_{w} \\ {Z}_{w} \\ 1\end{matrix} ] = M [ R \vert T ] [ \begin{matrix}{X}_{w} \\ {Y}_{w} \\ {Z}_{w} \\ 1\end{matrix} ] \qquad [ Equation 16 ]$$

A target of the evaluation function is F(s), which corresponds to coordinates in an actual image plane. Next, an input vector C (k=0) is initialized. Here, C refers to input vectors R and T.

Function F(C) is calculated using the input vectors in Equation 16 above.

Error function F(k)=F(s)−F(C) is calculated. Here, the error function compares values in an actual image plane with values obtained by substituting the input vectors R and T.

In addition, Equation 17 below is used to improve the input vectors.

C(k+1)=C(k)−[J(k)^{T}J(k)+αD(k)][J(k)^{T}F(k)] [Equation 17]

Here, J(k) is the derivative of F(k) with respect to C(k), and is a function for improving the input vectors in convergent directions. Here, k refers to the number of repetitions, and C refers to the input vectors R and T.

In addition, when Equation 18 below is satisfied, the calculation is terminated, and otherwise, Function F(C) is calculated again with respect to the input vectors.

ΔC=C(k+1)−C(k)<δ [Equation 18]

Here, δ is a threshold value for evaluating whether convergence has occurred.

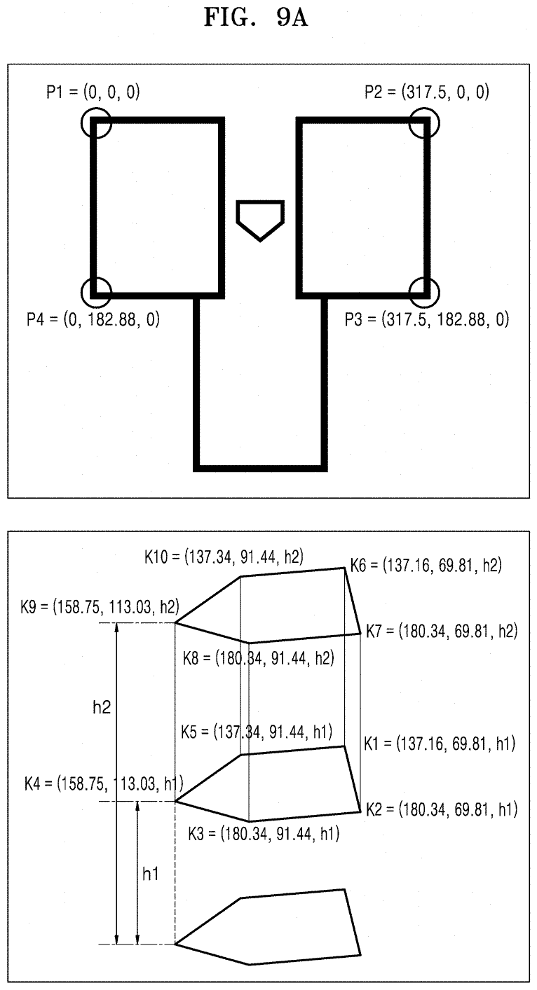

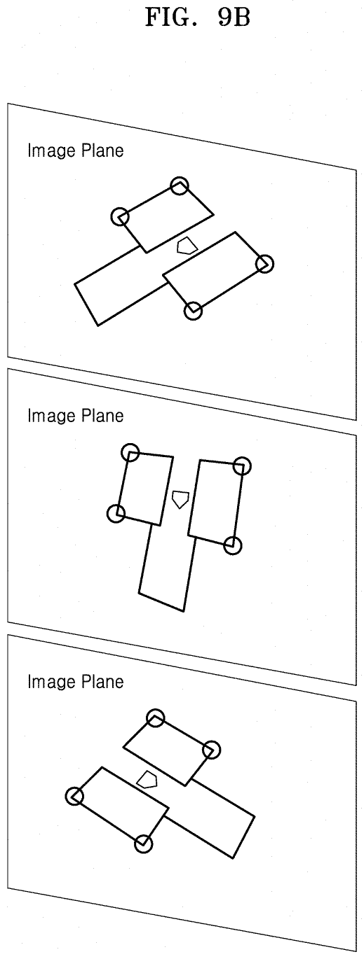

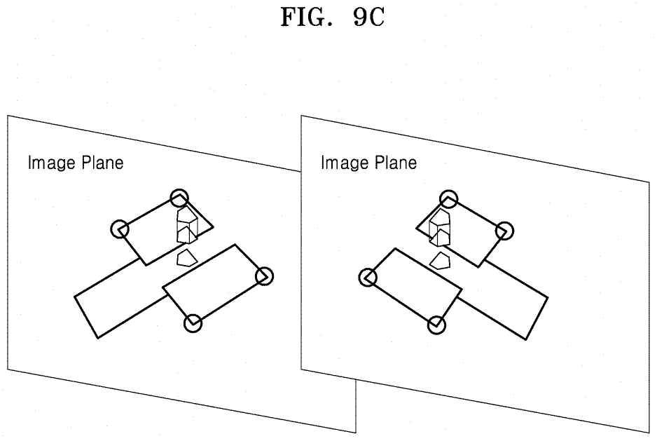

As shown in FIG. 9A, a 3D coordinate system is set based on the coordinates of at least four reference points of batter's boxes including a home plate. In addition, coordinates of a 3D strike zone are set in the 3D coordinate system.

As shown in FIG. 9B, 2D coordinates of the batter's boxes are acquired in a 2D image plane projected onto each of a plurality of cameras which are for generating a multichannel image. Here, as described with reference to Equations 1 to 18, rotation information and translation information are estimated based on corresponding coordinates between the 3D coordinate system and the 2D coordinates. Rotation information and translation information are estimated based on coordinates in an image plane of each of cameras (the cameras 1 to N shown in FIG. 2).

As shown in FIG. 9C, a 3D strike zone is displayed on the 2D image plane projected onto each of the plurality of cameras on the basis of the rotation information and translation information.

In an embodiment, the image processing unit 132 displays a 3D strike zone in a 2D image plane projected onto each of the plurality of cameras (the cameras 1 to N in FIG. 2) on the basis of rotation information and translation information estimated by the 3D strike zone generation unit 131.

The image processing unit 132 performs image correction on received multichannel images, that is, images captured by the plurality of cameras. For example, focal points of the images captured by the plurality of cameras may not match each other, and thus image processing is performed such that focal points of the cameras are the same. The image processing unit 132 corrects the received multichannel images. Geometric errors in the arrangement of N cameras cause visual shaking when the multichannel images are replayed, and thus, to remove this, at least one selected from the group consisting of the dimensions or size, the gradient, and the center position of each image may be corrected.

The image conversion unit 133 groups the multichannel images according to at least one of time, channel, or a combination of time and channel. The image conversion unit 133 groups several spaces as one space. Grouping may be performed according to various criteria According to an embodiment, the transmission system 100 may not transmit all image data but may transmit grouped images to prevent data waste and provide a user with only necessary data such that multichannel images or switching images may be effectively transmitted to the user terminal 150. The image conversion unit 133 may group channel images for ±y (y is a natural number) time periods based on an event at a time t. For example, an event may occur in a channel 1 at a time t3. Herein, the event may be a previously determined event such as a homerun or an out in a baseball game, an event that a user has requested, or any event that a user wants.

The image conversion unit 133 groups the multichannel images according to time, channel, or a combination of time and channel, and stores the grouped multichannel images in the image storage unit 140. When there is a request from the user terminal 150, the image processing device 130 extracts images from the image storage unit 140 and transmits the images to the user terminal 150 through the transmission unit 134. Here, the transmission unit 134 may be a streaming device, and although the transmission unit 134 is described as being included in the image server 200, the transmission unit 134 may be provided as an additional device separated from the image server 200.

The transmission unit 134 transmits processed images or stored images in real time. For example, the transmission unit 134 may be a device for real-time streaming. The transmission unit 134 may include: a message handler that performs session management and protocol management for a user terminal; a streamer that transmits images to a user terminal and contains groups of images to be sent to a user terminal; or a channel manager that receives a signal from a user and transmits images to the streamer after scheduling the images by GOP

Embodiments may be implemented in the form of recording media storing instructions executable on computers such as program modules. Computer readable media may be any media accessible by a computer, such as volatile media, non-volatile media, separable media, or non-separable media. The computer readable media may include computer storage media and communication media. Examples of the computer storage media include volatile media, non-volatile media, separable media, and non-separable media that are implemented by any method or technique for storing data such as computer instructions, data structures, or program modules. Examples of the communication media include mechanisms for transmitting computer readable instructions, data structures, program modules, data of modulated data signals such as carrier waves, other transmission mechanisms, and any information delivery media.

The description of the present disclosure is for illustrative purposes only, and it will be understood by those of ordinary skill in the art that modifications and changes in form may be made without departing from the technical ideas and essential features of the present disclosure. Therefore, the above-described embodiments should be considered in a descriptive sense only and not for purposes of limitation. For example, each element described above as an individual element may be provided in a distributed manner, and elements described above as being distributed may be provided in a combined form.

The scope of the present disclosure is defined not by the above description but by the following claims, and it should be construed that all modifications or changes made within the meaning and scope of the claims and equivalents thereof are within the scope of the present disclosure.

1. A method of displaying a 3D strike zone, the method comprising:
setting a 3D coordinate system based on coordinates of at least four reference points of batter's boxes including a home plate;
setting coordinates of the 3D strike zone which correspond to the 3D coordinate system;
acquiring 2D coordinates of the batter's boxes on a 2D image plane projected onto each of a plurality of cameras for generating a multichannel image;
estimating rotation information and translation information based on corresponding coordinates between the 3D coordinate system and the 2D coordinates; and
displaying the 3D strike zone on the 2D image plane projected onto each of the plurality of cameras based on the rotation information and translation information,
wherein the coordinates of the 3D strike zone are ten (K1 to K10), and each coordinate has one of two parameter values (h1 and h2), and two parameter values (h1 and h2) are variable depending on a height of a batter who is at bat.

2. The method of claim 1, wherein the rotation information and translation information are estimated based on the corresponding coordinates between the 3D coordinate system and the 2D coordinates by Levenberg-Marquardt optimization, Perspective-Three-Point, or a least-squares method.

3. (canceled)

4. The method of claim 1, wherein the height of the batter is extracted from an arbitrary database or by detection from an image of the batter.

5. The method of claim 1, further comprising detecting and tracking a trajectory of a pitch thrown by a pitcher,
wherein whether the pitch is a strike is determined by detecting whether the pitch passes through the displayed 3D strike zone.

6. An apparatus for displaying a 3D strike zone, the apparatus comprising:
a 3D coordinate setting unit that sets a 3D coordinate system based on coordinates of at least four reference points of batter's boxes including a home plate, and sets coordinates of the 3D strike zone which correspond to the set 3D coordinate system;
a 3D strike zone generation unit that acquires 2D coordinates of the batter's boxes on a 2D image plane projected onto each of a plurality of cameras for generating a multichannel image, and estimates rotation information and translation information based on corresponding coordinates between the 3D coordinate system and the 2D coordinates; and
an image processing unit that displays the 3D strike zone on the 2D image plane projected onto each of the plurality of cameras based on the rotation information and translation information,
wherein the coordinates of the 3D strike zone are ten (K1 to K10), and each coordinate has one of two parameter values (h1 and h2), and two parameter values (h1 and h2) are variable depending on a height of a batter who is at bat.

7. The apparatus of claim 6, wherein the rotation information and translation information are estimated based on the corresponding coordinates between the 3D coordinate system and the 2D coordinates by Levenberg-Marquardt optimization, Perspective-Three-Point, or a least-squares method.

8. (canceled)

9. The apparatus of claim 6, wherein the height of the batter is extracted from an arbitrary database or by detection from an image of the batter.

10. The apparatus of claim 6, further comprising a trajectory tracking unit that detects and tracks a trajectory of a pitch thrown by a pitcher,
wherein whether the pitch is a strike is determined by detecting whether the pitch passes through the displayed 3D strike zone.

11. A recording medium having recorded thereon a program for executing the method of claim 1.
